(19) United States
(12) Patent Application Publication
(10) Pub. No.: US 2010/0113856 A1
(43) Pub. Date: May 6, 2010

(54) APPARATUS AND METHOD FOR REMEDIATION OF AQUEOUS SOLUTIONS

(75) Inventor: Paul L. Edmiston, Wooster, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Absorbent Materials Company LLC

(21) Appl. No.: 12/560,043

(22) Filed: Sep. 15, 2009

Related U.S. Application Data
(63) Continuation-in-part of application No. 11/537,944, filed on Oct. 2, 2006.
(60) Provisional application No. 60/722,619, filed on Sep. 30, 2005.

(51) Int. Cl. B09B 5/00; C02F 5/10; B01D 15/00

(52) U.S. Cl. 588/249; 252/180; 252/181; 210/209

(57) ABSTRACT

A swellable sol-gel composition includes a plurality of interconnected organosilica nanoparticles. When dried, the swellable sol-gel composition is capable of swelling to at least twice its dried volume when placed in contact with a non-polar or organic sorbate.

### RELATED APPLICATIONS

This application is a continuation-in-part of U.S. patent application Ser. No. 11/537,944, filed Oct. 2, 2006, which claims priority from U.S. Provisional Patent Application Ser. No. 60/722,619, filed on Sep. 30, 2005 (now Expired). The subject matter of the aforementioned applications is hereby incorporated by reference in their entireties.

### TECHNICAL FIELD

The present invention generally relates to swellable sol-gel compositions and methods of use, and more particularly to methods for using swellable sol-gel compositions to remove non-polar and/or organic sorbates from aqueous solutions.

### BACKGROUND OF THE INVENTION

Substantial effort has been directed to the removal of contaminants from an aqueous media, such as ground water and precious metal recovery (e.g., mining or plating operations). Numerous “Superfund” sites have been established because of contamination of ground water, surface waters, and soils by various materials. The main contaminants are metals, particularly uranium and hexavalent chromium, volatile organic compounds (VOCs), high explosive compounds, nitrates, perchlorates, and tritium, as well as various commercial and manufacturing waste contaminants.

Presently, granular activated carbon (GAC), ion-exchanged resins, air-strippers, and bioremediation are used for contaminate removal. GAC has been commercially used as an adsorbent for contaminants in water (e.g., surface water, ground water, and industrial processes). GAC, however, has a limited VOC absorption capacity in terms of both the total quantity and type of VOCs removed from aqueous media, and cannot be regenerated after use.

### SUMMARY OF THE INVENTION

The present invention generally relates to swellable sol-gel compositions and methods of use, and more particularly to a method for using swellable sol-gel compositions to remove non-polar and/or organic sorbates from aqueous solutions.

One aspect of the present invention relates to an apparatus for removing an organic or non-polar sorbate from an aqueous solution. The apparatus can include a solid support structure and a swellable sol-gel composition disposed on or within the support structure. The swellable sol-gel composition can comprise a plurality of interconnected organosilica nanoparticles. When dried, the swellable sol-gel composition may be capable of swelling to at least twice its dried volume when placed in contact with a non-polar or organic sorbate.

Another aspect of the present invention relates to a method for removing an organic or non-polar sorbate from an aqueous solution. The method can comprise contacting the aqueous solution containing the organic or non-polar sorbate with a swellable sol-gel composition. The swellable sol-gel composition can be comprised of a plurality of interconnected organosilica nanoparticles. The swellable sol-gel composition may be capable of swelling to at least twice its dried volume when placed in contact with the organic or non-polar sorbate.

Another aspect of the present invention relates to a system for removing an organic or non-polar sorbate from an aqueous solution. The system can include a swellable sol-gel composition and a means for placing the swellable sol-gel composition in contact with the aqueous solution. The swellable sol-gel composition can be comprised of a plurality of interconnected organosilica nanoparticles. The swellable sol-gel composition may be capable of swelling to at least twice its dried volume when placed in contact with the organic or non-polar sorbate.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration showing an apparatus comprising a support structure and a swellable sol-gel composition for removing an organic or non-polar sorbate from an aqueous solution according to one aspect of the present invention;

FIG. 2 is a schematic illustration showing swellable organosilica nanoparticles comprising the swellable sol-gel composition that include a hydrophilic inner layer and an aromatic rich outer layer;

FIG. 3 is a schematic illustration showing a proposed model for absorption of dissolved organics by the swellable sol-gel composition based on electron microscopy;

FIG. 4 is a flow diagram illustrating a method for removing an organic or non-polar sorbate from an aqueous solution according to another aspect of the present invention;

FIG. 5 is a flow diagram illustrating a method for removing an organic or non-polar sorbate from an aqueous solution according to yet another aspect of the present invention;

FIG. 6 is a plot of bed volumes versus relative concentration showing breakthrough curves for 145 ppm PCE (100 mg bed volume, 0.5 mL/min) when applied to columns containing the swellable sol-gel composition, activated carbon, or molecular sieves;

FIG. 7 is a plot of bed volumes versus relative concentration showing breakthrough curves for 1200 ppm aqueous TCE (100 mg bed volume, 0.5 mL/min) when applied to columns containing the swellable sol-gel composition, activated carbon, or molecular sieves;

FIG. 8 is a plot of bed volumes versus relative concentration showing breakthrough curves for 470 ppm aqueous toluene (100 mg bed volume, 0.5 mL/min) when applied to columns containing the swellable sol-gel composition, activated carbon, or molecular sieves;

FIG. 9 is a plot of bed volumes versus relative concentration showing a breakthrough curve for 30 ppm aqueous naphthalene (100 mg bed volume, 0.5 mL/min) when applied to a column containing the swellable sol-gel composition; and

FIG. 10 is a plot of abundance versus time (minutes) showing chromatograms acquired by gas chromatography mass spectroscopy of water contaminated with >200 volatile organic compounds and organic acids (top line), and the same water treated with a 0.05% w/v swellable sol-gel composition/water in a stirred mixture extractor (bottom line).

### DETAILED DESCRIPTION

Unless otherwise defined, all technical terms used herein have the same meaning as commonly understood by one of ordinary skill in the art to which the present invention pertains.

In the context of the present invention, the term “swellable” can refer to the ability of a swellable sol-gel composition to swell greater than about 2 times its dried volume when placed in contact with a non-polar or organic sorbate. For example, the swellable sol-gel composition can swell greater than about 3 times, 4 times, 5 times, 6 times, 7 times, or greater its dried volume when placed in contact with an aqueous solution containing a non-polar or organic sorbate.

As used herein, the terms “non-polar sorbate” and “organic sorbate” can refer to a substance that is capable of being taken up by the swellable sol-gel composition of the present invention, whether by adsorption, absorption, or a combination thereof. Examples of non-polar and organic sorbates can include volatile organic compounds (VOCs) and organic acids.

As used herein, the terms “volatile organic compound” or “VOC” can refer to any hydrocarbon or other organic species having a boiling point that is less than or equal to about 250° C. Non-limiting examples of VOCs include methyl tert-butyl ether, hexane, octane, aromatic hydrocarbons, such as benzene, toluene, xylene, naphthalene, nitrobenzene, phenol, and m-nitrophenol, and chlorinated organics, such as trichloroethylene, perchloroethylene, dichloroethylene, vinyl chloride and polychlorinated biphenyls.

As used herein, the term “organic acid” can refer to any hydrocarbon or organic species having a pKₐ that is greater than about −3 and a log K_{ow} that is greater than about −0.32. Non-limiting examples of organic acids include organic species possessing at least one carboxylic acid group, at least one sulfonic acid group, at least one thiol group, or at least one enol group, sulfinic acids, protonated amines, phenols, naphthols, and hydroxamic acids.

The present invention generally relates to swellable sol-gel compositions and methods of use, and more particularly to methods for using swellable sol-gel compositions to remove non-polar and/or organic sorbates from aqueous solutions. The swellable sol-gel composition of the present invention is hydrophobic and does not swell in the presence of water or water vapor. Absorption by the swellable sol-gel composition is non-selective and can be induced by non-polar or organic sorbates ranging from methanol to hexane. Swelling and absorption of non-polar and/or organic sorbates is also driven by the release of stored tensile force rather than by chemical reaction. In fact, swelling is completely reversible if absorbed sorbates are removed by evaporation or rinse/drying. Compared to conventional sorbents (e.g., activated carbon, molecular sieves, etc.), the swellable sol-gel composition of the present invention has a higher capacity to absorb organic or non-polar sorbates and can be easily regenerated following absorption of non-polar or organic sorbates.

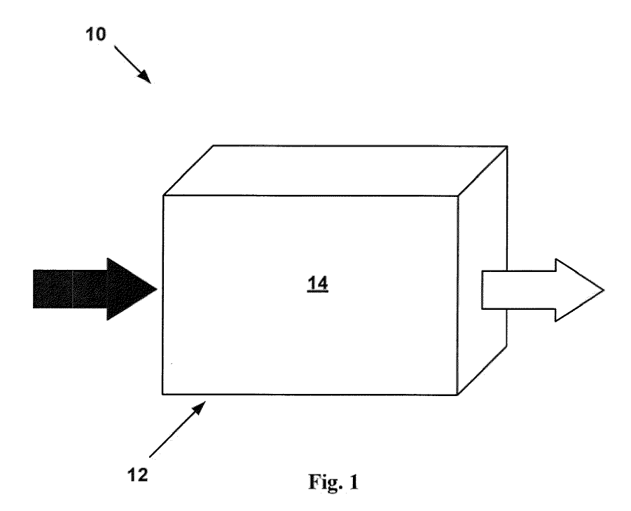

FIG. 1 schematically illustrates an apparatus 10 (FIG. 1) for removing an organic and/or non-polar sorbate from an aqueous solution. The apparatus 10 can include a support structure 12 and a swellable sol-gel composition 14. The swellable sol-gel composition 14 can be disposed on or within the support structure 12. The support structure 12 can comprise any type of solid or semi-solid object capable of directly or indirectly supporting the swellable sol-gel composition 14. For example, the support structure 12 can be any type of container, vessel, or material having at least one surface capable of supporting the swellable sol-gel composition 14. By “directly” it is meant that the swellable sol-gel composition 14 can be in intimate physical contact with at least one surface of the support structure 12. For example, the swellable sol-gel composition 14 can be attached, bonded, coupled to, or mated with all or only a portion of the at least one surface. By “indirectly” it is meant that the swellable sol-gel composition 14 can be housed by or within the support structure 12 without being in direct contact with the support structure. For example, the swellable sol-gel composition 14 can be afloat in a fluid (e.g., water) that is contained by the support structure 12.

In one example of the present invention, the support structure 12 can be a fixed bed reactor (e.g., a packed or fluidized bed reactor). The fixed bed reactor can contain a swellable sol-gel composition 14 so that the swellable sol-gel composition remains stationary or substantially stationary when an aqueous solution containing an organic or non-polar sorbate is flowed therethrough. The fixed bed reactor can include at least one inlet through which the aqueous solution is applied and at least one outlet through which an aqueous solution that is substantially free of the organic or non-polar sorbate(s) is discharged. The fixed bed reactor can additionally include an inert, non-swelling filler or media (e.g., ground glass) to provide void spaces for swelling of the swellable sol-gel composition 14. The fixed bed reactor can have any shape (e.g., cylindrical), dimensions, and orientation (e.g., vertical or horizontal). The fixed bed reactor may be stand-alone or placed directly in-line with an aqueous solution containing an organic or non-polar sorbate.

In another example of the present invention, the support structure 12 can be a filter. The filter can include at least one porous membrane that is entirely or partially formed with, coupled to, bonded with, or otherwise in intimate contact with the swellable sol-gel composition 14. For example, the filter can have a sandwich-like configuration and comprise a swellable sol-gel composition 14 disposed on or embedded between first and second porous membranes. The porous membrane can include a porous material (e.g., a metal, metal alloy, or polymer) having pores of sufficient size to permit passage of an organic or non-polar sorbate therethrough. For example, the porous membrane can be comprised of a nano- or micro-sized polymer or polymer-blended material, such as a nano-sized nylon-polyester blend.

In yet another example of the present invention, the support structure 12 can be a vessel capable of holding an aqueous solution containing an organic or non-polar sorbate. The vessel can comprise, for example, a stirred tank or vat. The swellable sol-gel composition 14 can be disposed on or embedded within at least one surface of the vessel. Alternatively, the swellable sol-gel composition 14 can be suspended (e.g., floating) in the aqueous solution contained within the vessel.

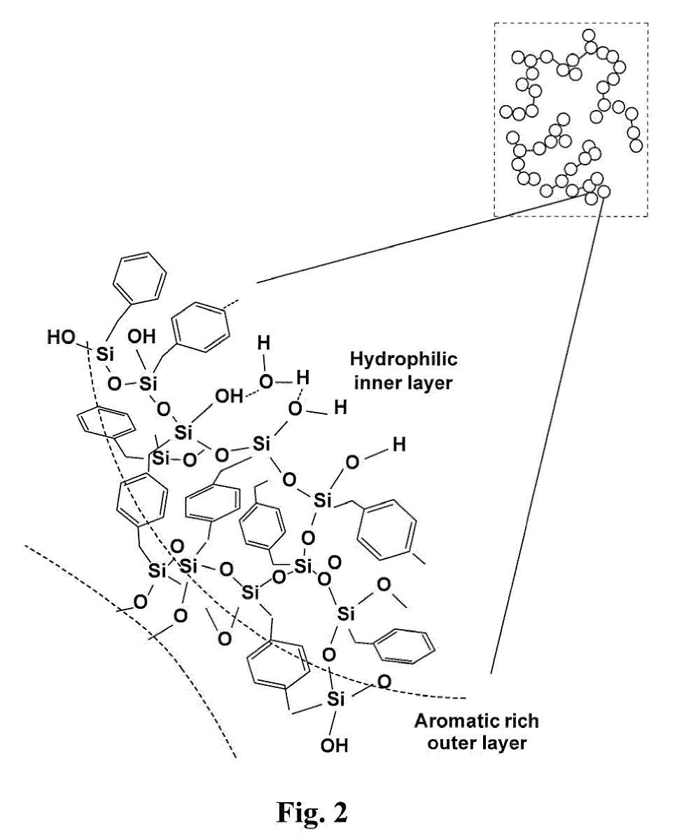

The swellable sol-gel composition 14 can be disposed on or within the support structure 12 and can be similar or identical to the swellable materials described in parent U.S. patent application Ser. No. 11/537,944 (hereinafter, “the '944 Application”). For example, the swellable sol-gel composition 14 can include a plurality of flexibly tethered and interconnected organosilica particles having diameters on the nanometer scale. The plurality of interconnected organosilica nanoparticles can form a disorganized microporous array or matrix defined by a plurality of cross-linked aromatic siloxanes. As shown in FIG. 2, the organosilica nanoparticles can have a multilayer configuration comprising a hydrophilic inner layer and a hydrophobic, aromatic-rich outer layer.

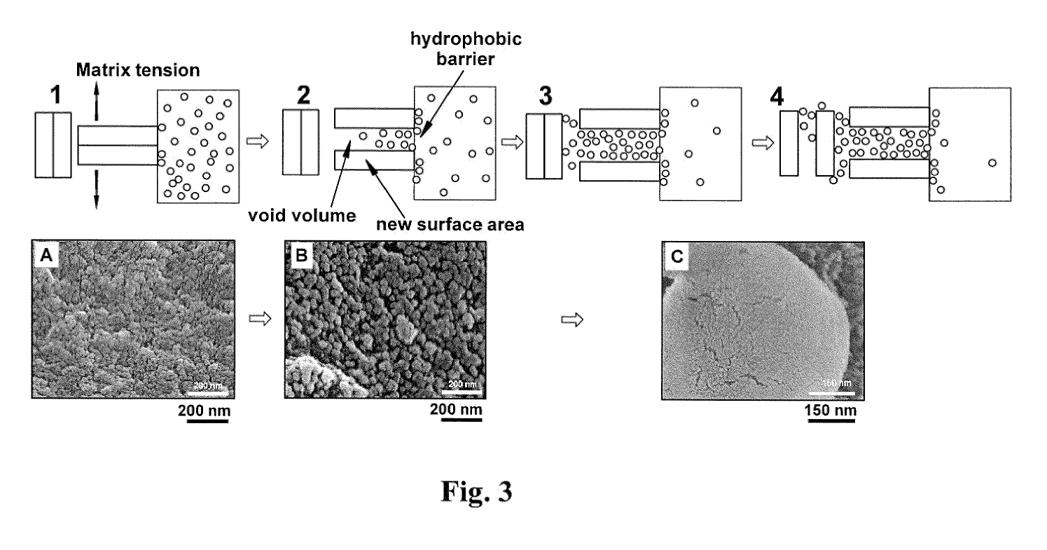

The swellable sol-gel composition 14 has the ability to swell to at least twice its dried volume when placed in contact with a non-polar or organic sorbate. Without being bound by theory, it is believed that swelling may be derived from the morphology of interconnected organosilica particles that are crosslinked during the gel state to yield a nanoporous material or polymeric matrix. Upon drying the gel and following a derivatization step, tensile forces may be generated by capillary-induced collapse of the polymeric matrix. Stored energy can be released as the matrix relaxes to an expanded state when non-polar or organic sorbates disrupt the inter-particle interactions holding the dried material in the collapsed state. New surface area and void volume may then be created, which serves to further capture additional non-polar or organic sorbates that can diffuse into the expanded pore structure. As shown in FIG. 3, for example, initial adsorption to the surface of the composition (FIG. 3-1) occurs in the dry, non-swollen state (FIG. 3A). Sufficient adsorption then occurs to trigger matrix expansion (FIG. 3-2), which leads to absorption across the composition-water boundary (FIG. 3B). Pore filling leads to further percolation into the composition (FIG. 3-3), followed by continued composition expansion to increase available void volume (FIG. 3C).

As described in the '944 Application, the organosilica nanoparticles can be formed from bridged polysiloxanes that include an aromatic bridging group, which is flexibly linked between silicon atoms of the polysiloxanes. Briefly, the organosilica nanoparticles can be formed from bridged silane precursors having the structure:

(alkoxy)₃Si—(CH₂)ₙ—Ar—(CH₂)ₘ—Si(alkoxy)₃

wherein n and m can individually be an integer from 1 to 8, Ar can be a single-, fused-, or poly-aromatic ring, and each alkoxy can independently be a C1 to C5 alkoxy. Examples of bridged silane precursors can include 1,4-bis(trimethoxysilylmethyl)benzene, bis(trimethoxysilylethyl)benzene (BTEB), and mixtures thereof.

Conditions for sol-gel formation can include polymerization of bridged silane precursor molecules using acid or base catalysts in appropriate solvents. Examples of base catalysts can include tetrabutyl ammonium fluoride (TBAF), sodium fluoride (or other fluoride salts), 1,5-diazabicyclo[4.3.0]non-5-ene (DBN), and alkylamines (e.g., propyl amine). Examples of solvents for use with base catalysts can include tetrahydrofuran (THF), acetone, and dichloromethane/THF mixtures. Examples of acid catalysts can include any strong acid, such as hydrochloric acid, phosphoric acid, and sulfuric acid. Solvents for use with acid catalysts can include those identified above for use with base catalysts.

After polymerization, the gelled composition can be aged for a duration of time effective to induce syneresis (e.g., from about 15 minutes to about 7 days). Solvent and catalyst extraction can be carried out (i.e., rinsing) after or during the aging process. After removing solvent and catalyst, the aged composition can be subjected to a derivatization step to end-cap the silanol-terminated polymers present in the gel. Reagents used for the derivatization step can include halosilane reagents containing at least one halogen group and at least one alkyl group. Examples of derivatization reagents are provided in greater detail below. Following derivatization, the derivatized gel can be rinsed and dried, e.g., in an oven for about 2 hours at about 60° C.

The swellable sol-gel composition 14 used to form the apparatus 10 can also include a particulate material. As described in the '944 Application, the swellable sol-gel composition 14 can be combined with the particulate material to form a swellable composite capable of binding to or reacting with a non-polar or organic sorbate. The swellable composite is hydrophobic, resistant to absorbing water, and capable of swelling to at least twice its dried volume when placed in contact with a non-polar or organic sorbate.

The particulate material can comprise any reactive or catalytic material that is capable of binding to or reacting with the non-polar or organic sorbate. For example, the particulate material can comprise a reactive metal that is capable of reducing organic sorbates, such as halogenated sorbates. Examples of reactive metals can include transition metals, such as zero valent iron (ZVI), palladium, gold, platinum, nickel and zinc. Other types of reactive or catalytic materials that may be used as the particulate material can include multifunctional solids that are catalytically active, such as zeolites (e.g., analcime, chabazite, clinoptilolite, heulandite, natrolite, phillipsite and stilbite), alumina, and activated/graphitic carbon as well as other reactive transition metals, alloys, metal oxides, and/or ceramics.

The particulate material can be entrapped within or disposed on the porous matrix or array of the swellable composite in a uniform or random configuration. For example, the particulate material can be randomly dispersed throughout the swellable sol-gel composition 14. Advantageously, particulate material entrapped within the porous matrix of the swellable sol-gel composition 14 can be potentially protected by the sol-gel to mitigate deactivation and/or poisoning of the particulate material.

The amount of particulate material that is provided in the swellable composite can be about 0.1% to about 10%, about 0.25% to about 8%, or, for example, about 0.5% to about 5% by weight of the composite.

The swellable composite can also include at least one metal catalyst deposited or coated onto a surface of the particulate material. As described below, the valency of the metal catalyst can be reduced to zero by the particulate material and result in the deposition of the metal catalyst onto at least one surface of the particulate material. The metal catalyst can be any one or combination of transition metals, such as palladium, nickel, and zinc. In one example of the present invention, the metal catalyst can comprise palladium.

Another aspect of the present invention includes a system for removing an organic and/or non-polar sorbate from an aqueous solution. The system can comprise a swellable sol-gel composition 14 and a means for placing the swellable sol-gel composition in contact with the aqueous solution. The swellable sol-gel composition 14 can comprise a plurality of interconnected organosilica nanoparticles and, depending upon the particular remediation activity, can optionally include a particulate material and/or metal catalyst. The means for placing the swellable sol-gel composition 14 in contact with the aqueous solution can be a support structure 12. As described above, the support structure 12 can comprise any type of solid or semi-solid object capable of directly or indirectly supporting the swellable sol-gel composition 14. Examples of support structures 12 are described above.

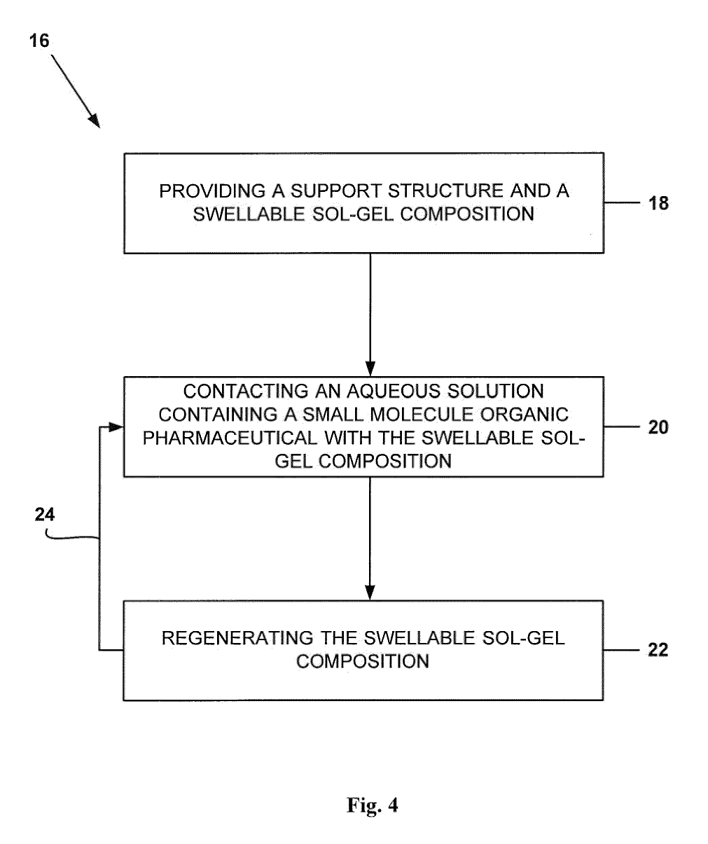

FIG. 4 illustrates another aspect of the present invention comprising a method 16 for removing an organic and/or non-polar sorbate from an aqueous solution. As described in more detail below, the method 16 can find use in a variety of organic or non-polar sorbate remediation applications, such as remediation of aqueous streams containing organic or non-polar sorbates produced by petroleum production or other industrial processes. The terms “remediating” and “remediation” can refer to the substantially complete removal of aqueous pollutants (i.e., non-polar and organic sorbates) to achieve the standard(s) set by the responsible regulatory agency for the particular contaminated aqueous media (e.g., National Primary Drinking Water Regulations for subsurface ground water).

As shown in FIG. 4, the method 16 can include providing a support structure 12 and a swellable sol-gel composition 14 at Step 18. As described above, the support structure 12 can comprise any type of solid or semi-solid object capable of directly or indirectly supporting the swellable sol-gel composition 14. The support structure 12 chosen at Step 18 will depend upon the particular type of remediation activity. As described in more detail below, for example, a support structure 12 comprising a fixed bed reactor may be used for in-line VOC or organic acid remediation. The swellable sol-gel composition 14 can comprise a plurality of interconnected organosilica nanoparticles and be disposed on or within the support structure 12. Depending upon the particular remediation activity, it will be appreciated that the swellable sol-gel composition 14 can optionally include a particulate material and/or metal catalyst.

At Step 20, the swellable sol-gel composition 14 can be contacted with an aqueous solution containing an organic or non-polar sorbate under conditions effective to cause the swellable sol-gel composition to take up the non-polar or organic sorbate. The aqueous solution can flow through or be placed into the support structure 12 so that intimate contact may be made between the swellable sol-gel composition 14 and the aqueous solution. If desired, the aqueous solution can be agitated to facilitate intimate contact between the swellable sol-gel composition 14 and the aqueous solution. Upon contact with the aqueous solution, stored energy in the sol-gel composition 14 can be released as the matrix relaxes to an expanded state when the non-polar or organic sorbate(s) disrupt the inter-particle interactions holding the dried material in the collapsed state. New surface area and void volume may then be created, which serves to further capture additional non-polar or organic sorbates that can diffuse into the expanded pore structure. Consequently, absorption of the non-polar or organic sorbates can cause the swellable sol-gel composition 14 to swell to at least twice its dried volume.

The aqueous solution can be contacted with the swellable sol-gel composition 14 until substantially all of the organic or non-polar sorbates have been removed from the aqueous solution, or until the swellable sol-gel composition is saturated with the organic or non-polar sorbates. The non-polar or organic sorbate is capable of being removed along with the swollen sol-gel composition, which is in a solid phase. For example, the swollen sol-gel composition can be directly removed or collected (e.g., using tactile means) from the support structure 12 or, alternatively, via centrifugation, filtration or floatation. Removal of the swollen sol-gel composition can leave behind an aqueous component that is substantially free of non-polar or organic sorbates. The remaining aqueous component can then be cleanly collected by pouring, aspiration, evaporation, distillation, or other means known in the art.

In one aspect of the method 16, the swellable sol-gel composition 14 can remove essentially all the non-polar or organic sorbates in the aqueous solution. If complete removal is desired, the contaminated aqueous solution can be contacted with enough of the swellable sol-gel composition 14 to avoid complete saturation of the composition or, alternatively, repeatedly contacted with fresh sol-gel composition until substantially complete extraction has been accomplished.

Additionally or alternatively at Step 22, the swollen sol-gel composition can be regenerated or recovered via chemical extraction and/or thermal treatment. For example, the swollen sol-gel composition can be heated for a period of time and at a temperature sufficient to separate the organic or non-polar sorbates from the sol-gel matrix.

At Step 24, the regenerated swellable sol-gel composition 14 may then be available for additional organic or non-polar sorbate extraction. Steps 22 and 24 can then be repeated until substantially all of the non-polar or organic sorbate is extracted from the aqueous solution.

As noted above, the type of apparatus 10 used to remove organic or non-polar sorbates from aqueous solutions will depend upon the particular type of remediation application. In one example of the method 16, an apparatus 10 comprising a fixed bed reactor and a swellable sol-gel composition 14 can be provided for high flow remediation of VOCs and/or organic acids. The fixed bed reactor can comprise a fluid inlet, a fluid outlet, and a swellable sol-gel composition 14 encased between two or more layers of a metal or metal alloy (e.g., stainless steel). The fixed bed reactor can be placed directly in-line with an aqueous solution containing the VOCs and/or organic acids. For example, the fixed bed reactor can be placed in-line with a contaminated water source that is constantly fed from a petroleum-producing facility. The contaminated water can be flowed through the inlet of the fixed bed reactor so that the VOCs and/or organic acids are absorbed by the swellable sol-gel composition 14. The water discharged from the outlet of the fixed bed reactor can be substantially free of VOCs and/or organic acids. As the swellable sol-gel composition 14 absorbs the VOCs and/or organic acids, the swollen sol-gel composition can be removed from the fixed bed reactor, regenerated (e.g., using thermal treatment), and then replaced (if needed) to continuously remove additional VOCs and/or organic acids.

In another example of the method 16, an apparatus 10 comprising a filter and a swellable sol-gel composition 14 can be provided for low flow extraction of VOCs and/or organic acids. The filter can be comprised of first and second nano-porous, polymeric membranes (e.g., nylon-polyester blend) having the swellable sol-gel composition 14 disposed therebetween. The filter can be placed directly in-line with a water source contaminated with VOCs and/or organic acids. The contaminated water can be flowed through the filter so that the VOCs and/or organic acids are absorbed by the swellable sol-gel composition 14 and thereby extracted from the water. The water that has been passed through the filter can be substantially free of VOCs and/or organic acids. As the swellable sol-gel composition 14 absorbs the VOCs and/or organic acids and becomes swollen, the filter can be removed from the polluted water stream, the sol-gel composition regenerated (e.g., using thermal treatment), and the filter then placed back into the stream to remove additional VOCs and/or organic acids. It will be appreciated that a new filter may also be used to replace the used filter, and that two or more filters may be used to extract the VOCs and/or organic acids.

In yet another example of the method 16, a support structure 12 comprising a fillable tank or vat can be used to extract VOCs and/or organic acids from a contaminated aqueous solution. Either prior to, simultaneous with, or subsequent to addition of the contaminated aqueous solution to the fillable tank or vat, an amount of the swellable sol-gel composition 14 can be added to the fillable tank or vat. The contaminated aqueous solution can then be mixed thoroughly using mechanical means or through fluid agitation (e.g., a vortex system). Contact of the swellable sol-gel composition 14 with the contaminated aqueous solution allows the VOCs and/or organic acids to be absorbed by the swellable sol-gel composition. As the swellable sol-gel composition 14 absorbs the VOCs and/or organic acids and becomes swollen, the swollen sol-gel composition can be removed from the fillable tank or vat via floatation, filtration, and/or centrifugation. The removed sol-gel composition can then be regenerated (e.g., using thermal treatment) and, if necessary, added to the fillable tank or vat to remove additional VOCs and/or organic acids.

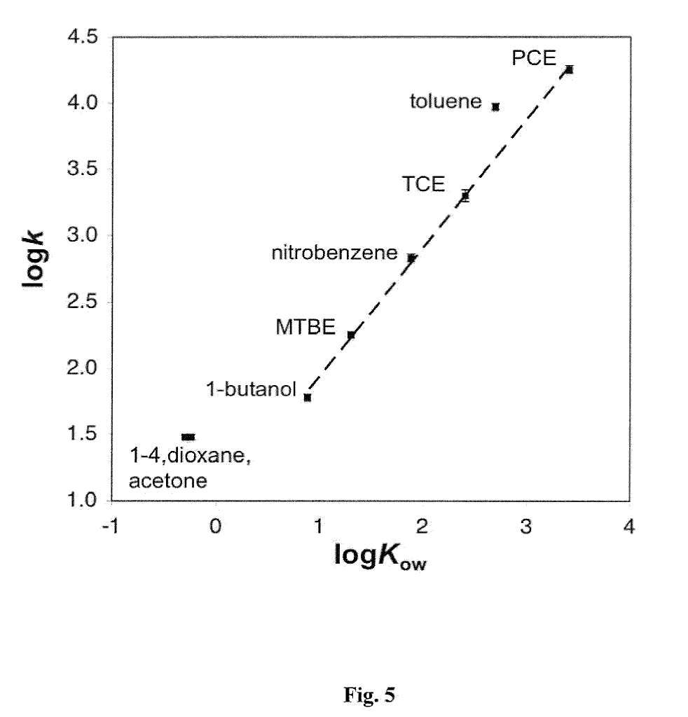

FIG. 5 illustrates a method 26 for removing an organic and/or non-polar sorbate from an aqueous solution in accordance with another aspect of the invention. Similar to the method 16 described above, the method 26 shown in FIG. 5 can find use in a variety of organic or non-polar sorbate remediation applications, such as remediation of aqueous chemical spills. For example, the method 26 can find use in any aqueous environment that has been contaminated with non-polar or organic sorbates, such as VOCs and/or organic acids. Other examples of remediation applications in which the method 26 can find use can include any water environment that has been contaminated with oil, such as motor oil, crude oil, or oily waste, clean-up of ground water that has been contaminated with oil (e.g., by pumping the ground water out and contacting it with the swellable sol-gel composition 14), and cleaning oil spills in the oceans and rivers, waste oil deposits in harbors, and environmental spills by industries.

As shown in FIG. 5, the method 26 can include providing a swellable sol-gel composition 14 at Step 28. The swellable sol-gel composition 14 can comprise a plurality of interconnected organosilica nanoparticles and, depending upon the particular remediation activity, can additionally or optionally include a particulate material and/or metal catalyst.

At Step 30, the swellable sol-gel composition 14 can be contacted with the aqueous solution under conditions effective to cause the swellable sol-gel composition to take up the non-polar or organic sorbates. The manner in which the swellable sol-gel composition 14 is contacted with the aqueous solution will depend upon the type of remediation activity. For example, the swellable sol-gel composition 14 can be spread as a powder across a contaminated aqueous solution by hand or a spreading device. Alternatively, the swellable sol-gel composition 14 can be encased in a device capable of skimming the surface of a contaminated aqueous solution.

Upon contact with the contaminated aqueous solution, stored energy in the swellable sol-gel composition 14 can be released as the matrix relaxes to an expanded state when the non-polar or organic sorbate(s) disrupt the inter-particle interactions holding the dried material in the collapsed state. New surface area and void volume may then be created, which serves to further capture additional non-polar or organic sorbates that can diffuse into the expanded pore structure. Consequently, absorption of the non-polar or organic sorbates can cause the swellable sol-gel composition 14 to swell to at least twice its dried volume.

The contaminated aqueous solution can be contacted with the swellable sol-gel composition 14 until substantially all of the organic or non-polar sorbates have been removed from the aqueous solution, or until the swellable sol-gel composition is saturated with the organic or non-polar sorbates. The non-polar or organic sorbate is capable of being removed along with the swollen sol-gel composition, which is in a solid phase. For example, the swollen sol-gel composition can be directly removed or collected (e.g., using tactile means). Removal of the swollen sol-gel composition can leave behind an aqueous component that is substantially free of non-polar or organic sorbates.

In one aspect of the method 26, the swellable sol-gel composition 14 can remove essentially all the non-polar and/or organic sorbates from the contaminated aqueous solution. If complete removal is desired, the contaminated aqueous solution can be contacted with enough of the swellable sol-gel composition 14 to avoid complete saturation of the composition or, alternatively, repeatedly contacted with fresh sol-gel composition until substantially complete extraction has been accomplished.

Additionally or alternatively at Step 32, the swollen sol-gel composition 14 can be regenerated or recovered via chemical extraction and/or thermal treatment. For example, the swollen sol-gel composition 14 can be heated for a period of time and at a temperature sufficient to separate the organic or non-polar sorbates from the sol-gel matrix.

At Step 34, the regenerated swellable sol-gel composition 14 may then be available for additional organic and/or non-polar sorbate extraction. Steps 32 and 34 can then be repeated until substantially all of the non-polar and/or organic sorbate is extracted from the contaminated aqueous solution.

In one example of the method 26, the swellable sol-gel composition 14 can be contacted with an oil spill or a waste oil deposit in a lake, harbor, or ocean. For example, the swellable sol-gel composition 14 can be spread in powder form across the oil spill or, alternatively, the swellable sol-gel composition can be encased in a flexible porous casing to create a boom or stick. After contacting the swellable sol-gel composition 14 with the oil spill, the VOCs and/or organic acids comprising the oil spill can be absorbed by the swellable sol-gel composition, thereby causing the sol-gel composition to swell to at least twice its dried volume.

Where the swellable sol-gel composition 14 is spread across the surface of an oil spill, for example, the swollen sol-gel composition will float on the surface of the water. Alternatively, a boom or stick containing the swellable sol-gel composition 14 can be dragged across the surface of the water through the oil spill to promote absorption of the VOCs and/or organic acids by the swellable sol-gel composition. Upon collection of the swollen sol-gel composition, the sol-gel composition can be regenerated at Step 32 and, if needed, re-applied at Step 34 to the oil spill until substantially all of the VOCs and/or organic acids are removed from the water.

The following examples are for the purpose of illustration only and are not intended to limit the scope of the claims, which are appended hereto.

### Example 1

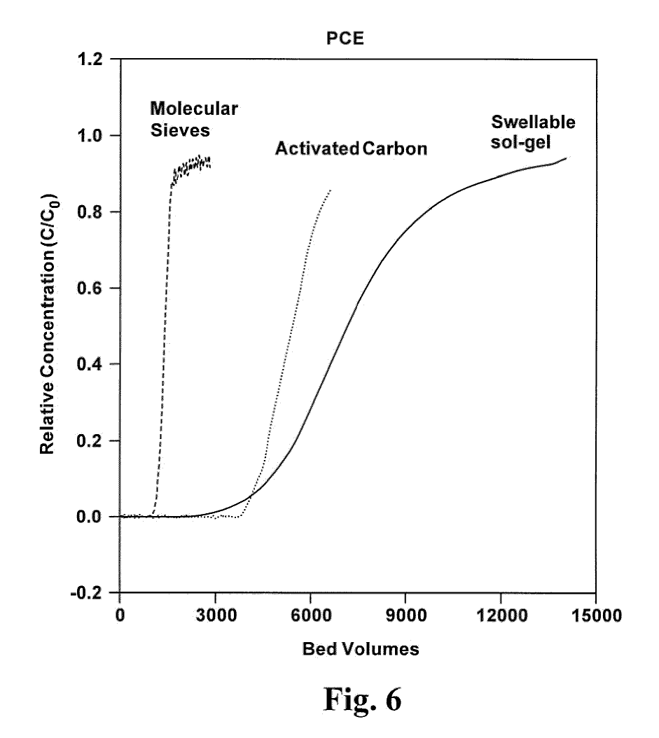

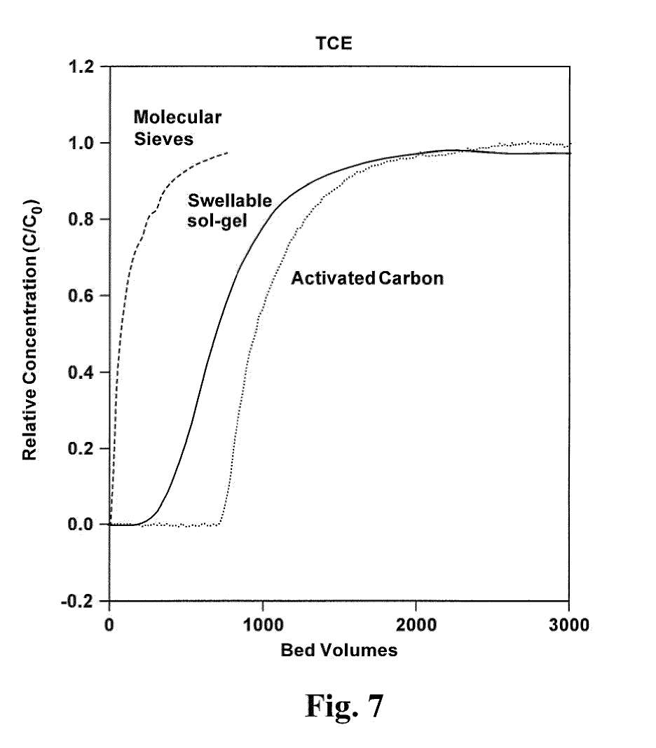

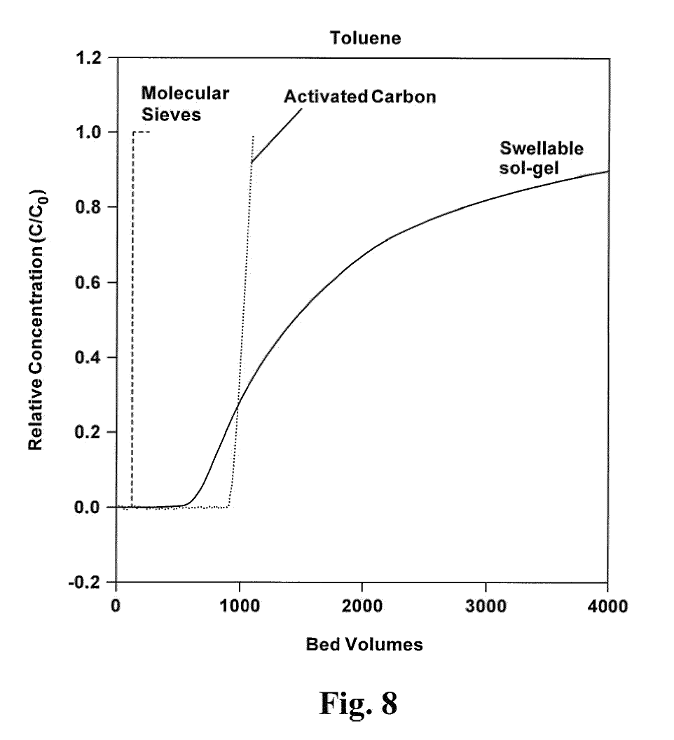

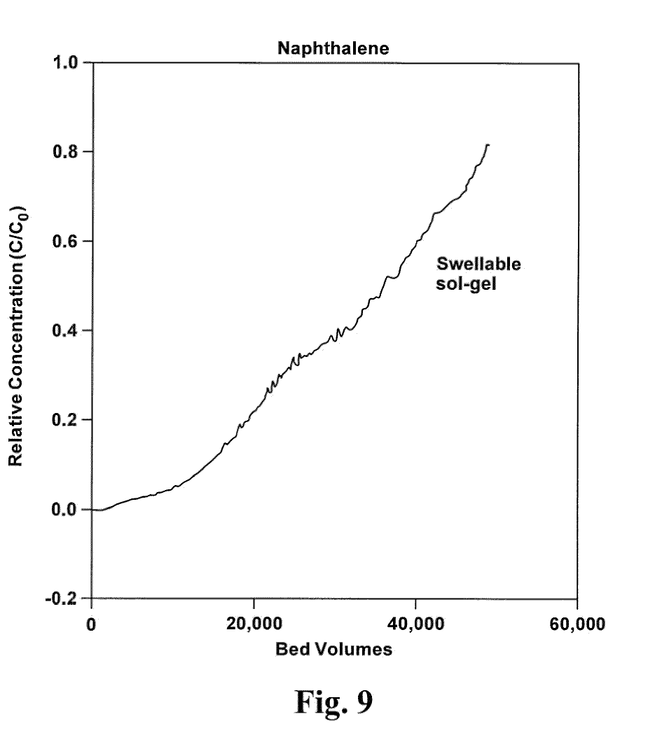

Absorption of perchloroethylene (PCE), trichloroethylene (TCE), toluene, and naphthlene from water by a fixed bed was studied compared to other sorbents (FIGS. 6-9). Stainless steel columns (3 mL volume) were packed with 100 mg of a swellable sol-gel composition, activated charcoal (DARCO®, G-60 powder), or molecular sieves (organophilic, 3-5 μm particle size) mixed in 2.5 g of ground glass. The contaminants were present in aqueous solution as follows: PCE (145 ppm); TCE (1200 ppm); toluene (470 ppm); and napthlene (30 ppm). The void volume and/or residual adsorption activity was determined by measuring an identical column packed only with ground glass and 100 mg of glass powder. Water with dissolved contaminants was pumped through the packed columns at a rate of 0.5 mL/min The concentration of contaminants in the eluent was measured in real-time by UV spectrometry using Waters 2487 UV detector or by refractive index (MTBE) using a Waters 410 differential refractometer. Samples of the eluent and stock solutions were taken during the experiment and analyzed by GC-MS to confirm the concentration pre- and post-measurement.

The swellable sol-gel composition had a higher capacity for contaminants compared to activated carbon. The function can be quantitated by the amount of absorbed contaminant at breakthrough as defined by the concentration eluting bed/concentration entering bed=0.1 (0.7 g PCE/g swellable sol-gel composition) and by the amount of contaminant absorbed when capacity has been reached as defined by concentration eluting bed/concentration entering bed=0.0 (1.1 g PCE/g swellable sol-gel composition).

### Example 2

Absorption of PCE dissolved in water via a stirred mixture was tested at various concentrations (Table 1).

TABLE 1
Absorption Data for Perchloroethylene (PCE)*

| | | | μg PCE abs/mg |
|---|---|---|---|
| | Percent | Partition | Swellable Sol-Gel |
| Concentration (ppm) | Extraction^{§} | Coefficient/10³ | Composition |
| 1.0 | 98.0 ± 0.2 | 4.0 ± 0.8 | 0.2 |
| 8.0 | 97.3 ± 0.2 | 6.3 ± 0.8 | 0.7 |
| 30 | 99.3 ± 0.1 | 21 ± 1 | 6.2 |
| 70 | 98.9 ± 0.2 | 19 ± 4 | 13.6 |
| 145 | 98.8 ± 0.1 | 16 ± 2 | 28.3 |

*Mass swellable sol-gel composition/volume solution = 0.5% w/v.
Temperature = 25° C.
^{§}n = 3 for all measurements

Stock solutions of dissolved PCE were prepared by adding an excess amount of PCE to water. The water-PCE mixture was shaken for 15 minutes and allowed to rest for 24 hours to create a saturated stock solution which was verified by gas chromatography and used to prepare test solutions. Samples of a swellable sol-gel composition were added to sealed vials with PCE and allowed to equilibrate for at least 5 minutes. The volume of head-space over test solutions was minimized and the samples sealed at all times. Concentration after addition of the swellable sol-gel composition was measured by a direct aqueous injection method (L. Zwank et al., Environ. Sci. Technol. 36:2054-2059, 2002) for test solutions having an initial concentration ≧1.0 ppm.

A 10 m×0.53 mm HYDROGUARD column (Restek, Bellefonte, Pa.) in series with a 60 m×0.32 mm×1 μm STABILWAX GC column (Restek, Bellefonte, Pa.) were used for all direct injection measurements. Calibration curves were run using standards (SUPLECO) diluted in Type I water. Dilute samples (<1.0 ppm) were measured by solid-phase microextraction using a SUPELCO divinylbenzene/Carboxen/polydimethylsiloxane fiber and gas chromatography mass spectroscopy (Niri, V. H. et al., J. Chromatogr. A 1201:222-227, 2008) using an Agilent 30 m MS-5 capillary GC column. Detection was done with an Agilent 5973 MS using selective ion monitoring. Partition coefficients for an organic contaminant (OC) (e.g., PCE) between the swellable sol-gel composition and water were calculated by the following equation:

$${k}_{OC} = \frac{{molesOC}_{SOMS} / {mass}_{SOMS}}{{molesOC}_{solution} / {volume}_{solution}}$$

### Example 3

1.0×1.0 cm sheets of membrane were placed in 10 mL of solution contaminated with either trichloroethylene (TCE) or PCE (10 ppm and 50 ppm in water) (Tables 2 and 3).

TABLE 2
Absorption Data for TCE

| | Mass swellable sol- | | Partition |
|---|---|---|---|
| Polymer | gel/volume H₂O (%) | Percent Extraction | Coefficient/10³ |
| Swellable | 0.5% | 84 ± 1 | 1.3 ± 0.2 |
| sol-gel only | | | |
| Nylon 1 | 2.5% | 99.5 | 7.2 |
| Nylon 2 | 2.5% | 98 ± 1 | 2.8 ± 1.5 |
| Nylon 3 | 2.5% | 98 ± 1 | 1.9 ± 0.7 |

TABLE 3
Absorption Data for PCE

| | | Percent | Partition |
|---|---|---|---|
| Polymer | Concentration (ppm) | Extraction | Coefficient/10⁴ |
| Swellable sol-gel | 50 | 99.3 | 2.1 |
| Swellable sol-gel | 10 | 97.3 | 0.6 |
| Nylon 1 | 50 | 99.9 | 4.6 |
| Nylon 1 | 10 | 99.9 | 4.2 |
| Nylon 2 | 50 | 99.5 | 1.0 |
| Nylon 2 | 10 | 99.8 | 3.0 |
| Nylon 3 | 50 | 99.6 | 1.3 |
| Nylon 3 | 10 | 99.8 | 2.5 |
| Nylon 4 | 50 | 99.7 | 1.3 |
| Nylon 4 | 10 | 99.9 | 6.5 |

The solution containing the filter membranes were shaken for at least 30 minutes and the resulting concentration of contaminant in the water was measured by gas chromatography using a electron capture detector and mass spectrometer detector. Membranes were then removed from solution and heated at 60° C. for 30 minutes to regenerate the swellable sol-gel composition. The filters were then tested in the same manner to test their ability to be regenerated and reused. Filter membranes lacking any embedded/entrapped swellable sol-gel composition were also tested to measure the degree the polymer membrane itself contributed to absorption. This was generally in the range of 5-20% of the total amount extracted.

### Example 4

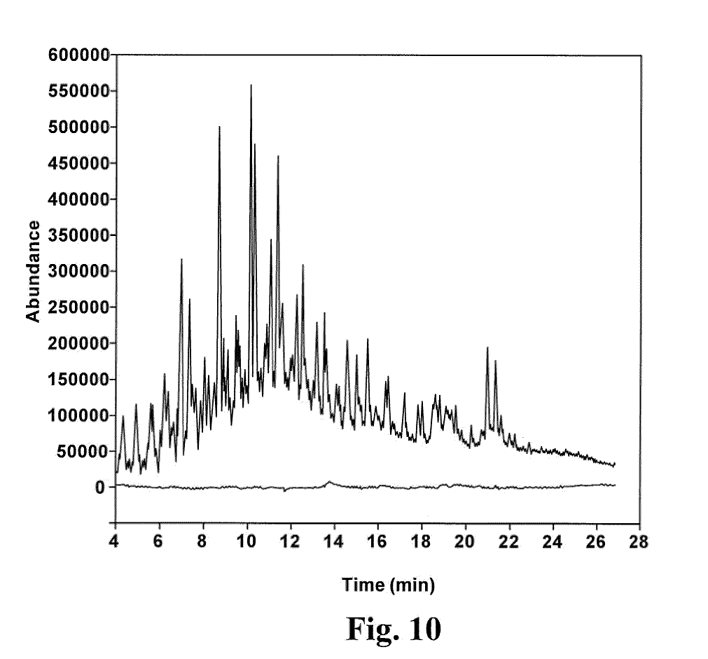

Extraction of a mixture containing greater than 200 VOCs and organic acids in water was tested using the swellable sol-gel composition as described in Example 2. Using a stirred mixture of contaminated water and 0.05% w swellable sol-gel/v water, it was found that greater than 99% of all VOCs and organic acids were removed as tested by gas chromatography-mass spectroscopy (FIG. 10).

From the above description of the invention, those skilled in the art will perceive improvements, changes and modifications. Such improvements, changes, and modifications are within the skill of the art and are intended to be covered by the appended claims.

Having described the invention, the following is claimed:

1. An apparatus for removing an organic or non-polar sorbate from an aqueous solution, the apparatus comprising:
a support structure; and
a swellable sol-gel composition disposed on or within the support structure, the swellable sol-gel composition comprising a plurality of interconnected organosilica nanoparticles, the sol-gel composition when dried being capable of swelling at least twice its dried volume when placed in contact with a non-polar or organic sorbate.

2. The apparatus of claim 1, the swellable sol-gel composition being hydrophobic and resistant to absorbing water.

3. The apparatus of claim 1, wherein the change of volume of the sol-gel composition by absorption of the non-polar or organic sorbate generates forces of at least 100 N/g.

4. The apparatus of claim 1, the organosilica nanoparticles comprising polysiloxanes with an organic bridging group.

5. The apparatus of claim 4, including an aromatic bridging group flexibly linked between silicon atoms of the polysiloxanes.

6. The apparatus of claim 1, further comprising a particulate material that is capable of binding to or reacting with the non-polar or organic sorbate.

7. The apparatus of claim 6, the particulate material comprising a reactive metal.

8. The apparatus of claim 7, the reactive metal comprising at least one of zero-valent iron (ZVI), palladium, gold, platinum, nickels, zinc, and combinations thereof.

9. The apparatus of claim 1, the support structure comprising a fixed bed.

10. The apparatus of claim 9, the fixed bed including an inert filler.

11. The apparatus of claim 1, the support structure comprising a filter.

12. The apparatus of claim 1, the non-polar or organic sorbate comprising a volatile organic compound.

13. The apparatus of claim 1, the non-polar or organic sorbate comprising an acidic organic molecule.

14. A method for removing an organic or non-polar sorbate from an aqueous solution, the method comprising the step of:
contacting the aqueous solution containing the organic or non-polar sorbate with a swellable sol-gel composition under conditions effective to cause the swellable sol-gel composition to take up the non-polar or organic sorbate, the swellable sol-gel composition comprising a plurality of interconnected organosilica particles;
wherein the swellable sol-gel composition is capable of swelling to at least twice its dried volume when placed in contact with the non-polar or organic sorbate.

15. The method of claim 14, the contacting step further comprising the step of agitating the aqueous solution containing the organic or non-polar sorbate and the swellable sol-gel composition.

16. The method of claim 14, further comprising the steps of:
collecting the swollen sol-gel composition; and
separating the organic or non-polar sorbate from the sol-gel composition.

17. The method of claim 14, the swellable sol-gel composition being disposed on or within a support structure.

18. The method of claim 17, the support structure comprising a fixed bed.

19. The method of claim 18, the fixed bed including an inert filler.

20. The method of claim 17, the support structure comprising a filter.

21. The method of claim 14, the non-polar or organic sorbate comprising a volatile organic compound.

22. The method of claim 14, the non-polar or organic sorbate comprising an acidic organic molecule.

23. The method of claim 14, the aqueous solution containing the organic or non-polar sorbate comprising a chemical spill.

24. The method of claim 23, the chemical spill comprising an oil spill.

25. A system for removing an organic or non-polar sorbate from an aqueous solution, the system comprising:
a swellable sol-gel composition comprising a plurality of interconnected organosilica particles, the swellable sol-gel composition being capable of swelling to at least twice its dried volume when placed in contact with the non-polar or organic sorbate; and
means for placing the swellable sol-gel composition in contact with the aqueous solution.

26. The system of claim 25, the swellable sol-gel composition being hydrophobic and resistant to absorbing water.

27. The system of claim 25, wherein the change of volume of the sol-gel composition by absorption of the non-polar or organic sorbate generates forces of at least 100 N/g.

28. The system of claim 25, the organosilica nanoparticles comprising polysiloxanes with an organic bridging group.

29. The system of claim 28, including an aromatic bridging group flexibly linked between silicon atoms of the polysiloxanes.

30. The system of claim 25, further comprising a particulate material that is capable of binding to or reacting with the non-polar or organic sorbate.

31. The system of claim 30, the particulate material comprising a reactive metal.

32. The system of claim 31, the reactive metal comprising at least one of ZVI, palladium, gold, platinum, nickels, zinc, and combinations thereof.

33. The system of claim 25, the means for placing the swellable sol-gel composition in contact with the aqueous solution comprising a support structure.

34. The system of claim 33, the support structure comprising a fixed bed.

35. The system of claim 34, the fixed bed including an inert filler.

36. The system of claim 33, the support structure comprising a filter.

37. The system of claim 25, the non-polar or organic sorbate comprising a volatile organic compound.

38. The system of claim 25, the non-polar or organic sorbate comprising an acidic organic molecule.
